(19) United States
(12) Patent Application Publication
(10) Pub. No.: US 2003/0071886 A1
(43) Pub. Date: Apr. 17, 2003

(54) Luminous color printing

(76) Inventor: Yueh-Pao Chang, Taipei Hsien (TW)

Correspondence Address: Yueh-Pao Chang, P.O. Box No.6-57, Chung-Ho, Taipei, 235, TW

(21) Appl. No.: 09/977,691

(22) Filed: Oct. 16, 2001

(51) Int. Cl. B41J 2/315

(52) U.S. Cl. 347/171

(57) ABSTRACT

The present invention provides a method of luminous color printing and the main formula comprises 70% luminous powder plus 30% fluorescent powder plus 1:1 transparent printing oil; after being mixed by a machine and ground by three tumblers, the four primary printing colors are blended and ready to be applied in the manufacturing procedures, such as the thermal transfer printing or the aqua transfer printing; through the mixture and the blending of the luminous powder, the fluorescent powder and the transparent printing oil, the colorful patterns can be printed directly on and according to the different materials, such as the label paper, the poster, the calendar, the decoration, the clothes and the external case of a mobile phone; in addition, the said colorful patterns are capable of storing the light during the daytime and showing the visible luminous colorful patterns during the nighttime.

### BACKGROUND OF THE INVENTION

a) Field of the Invention

The present invention is a method of luminous color printing, more specifically, through the mixture and the blending of the luminous powder, the fluorescent powder and the transparent printing oil, the colorful patterns printed on the different materials such as the label paper, the poster, the calendar, the decoration, the clothes and the external case of a mobile phone are capable of storing the light during the daytime and showing the visible luminous colorful patterns during the nighttime, thereby the practical value of the economic efficiency can be increased.

b) Description of the Prior Art

Accordingly, the available printing methods can be divided into the thermal transfer printing and the aqua transfer printing, wherein the thermal transfer printing uses the form separating paper of polyvinyl chloride (PVC) to print the four primary colors of printing on the form separating paper of PVC, then transfer and paste them onto the clothes, the external case of the mobile phone and the plastics; the aqua transfer printing uses the simile paper spread with the form separating agent; the four primary colors of printing are printed on the form separating agent on the simile paper first, then they are transferred and pasted onto the materials, such as the glass, the ceramic, the porcelain, the enamel, the marble, the wood apparatus and the leather.

In view of the mentioned methods, although two available printing methods are capable of printing the colorful patterns onto the different materials, such as the clothes, the external case of the mobile phone, the plastics, the ceramic, the porcelain, the enamel, the glass, the marble, the wood apparatus and the leather, the said colorful patterns are visible only during the daytime but not the nighttime. For the young people pursuing fashion, that seems a little bit boring and less innovative and lowers their desires of purchasing the related product; furthermore, the general pedestrians walking during the nighttime, usually have no reflective or luminous objects on their bodies for distinguishing and they might easily be hit unintentionally by the drivers of the running cars in traffic accidents. The inventor of the present invention, addressed the mentioned shortcomings, based on the experience and professional techniques obtained from the engagement in the related industrial for many years, further researched and developed a formula composition to provide a method of luminous color printing with more practicality and security.

To enable a further understanding of the technical contents of the present invention, the brief description of the drawings below is followed by the detailed description of the preferred embodiment.

### SUMMARY OF THE INVENTION

The primary objective of the present invention is to mix 70% luminous powder plus 30% fluorescent powder plus 1:1 transparent printing oil by a machine and to be printed on different materials; the said colorful patterns are capable of storing the light during the daytime and showing the visible luminous colorful patterns during-the nighttime.

### BRIEF DESCRIPTION OF THE DRAWINGS

FIG. 1 is a flow chart of the manufacture of the present invention.

FIG. 2 is a flow chart of the manufacture of the thermal transfer printing of the present invention.

FIG. 3 is a flow chart of the manufacture of the aqua transfer printing of the present invention.

### DETAILED DESCRIPTION OF THE PREFERRED EMBODIMENTS

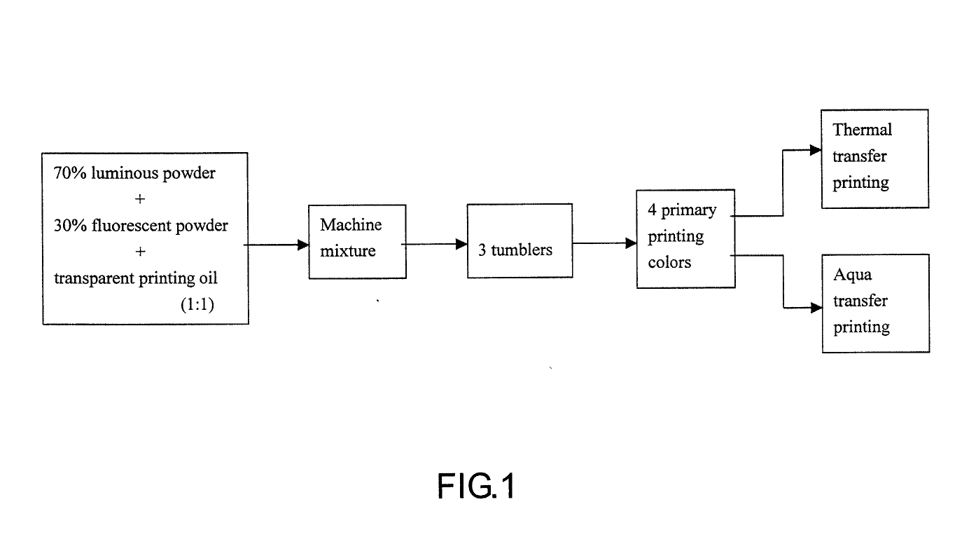

Referring to FIG. 1, the present invention can be applied in the manufacturing procedures of a thermal transfer printing and an aqua transfer printing; the present invention is a luminous color printing and the main formula thereof comprises the luminous powder, the fluorescent powder and the transparent printing oil; the feature thereof is that 70% luminous powder plus 30% fluorescent powder plus 1:1 transparent printing oil are mixed by a machine and ground by three tumblers into four blended primary printing colors ready to be applied in the manufacturing procedures, such as the thermal transfer printing or the aqua transfer printing.

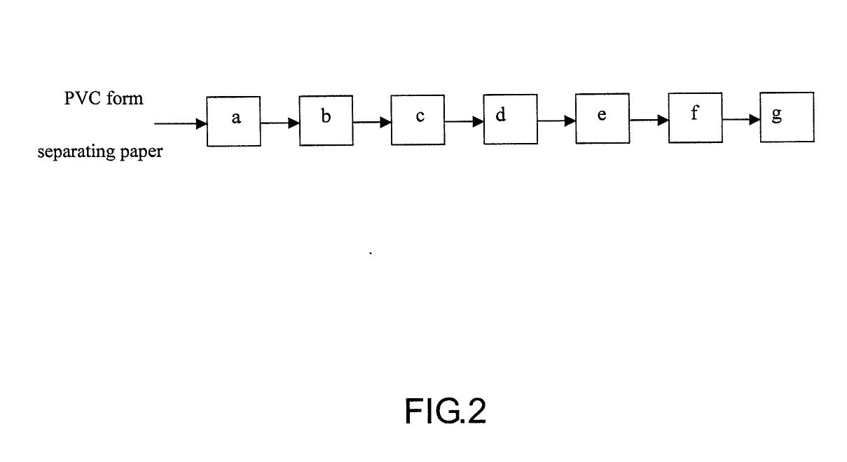

Referring to FIG. 2, when the present invention is applied in the manufacturing procedures of the thermal transfer printing, the form separating paper of polyvinyl chloride (PVC) is used first, then the other materials are used according to the printing sequence: a. the form separating agent, b. the black color, c. the blue color, d. the red color, e. the yellow color, f. the white color, g. the adhesive glue; the accomplishment of the manufacturing procedures completes the thermal transfer paper printing; then this piece of paper is transferred and pasted onto different materials, such as the clothes, the external case of a mobile phone and the plastics.

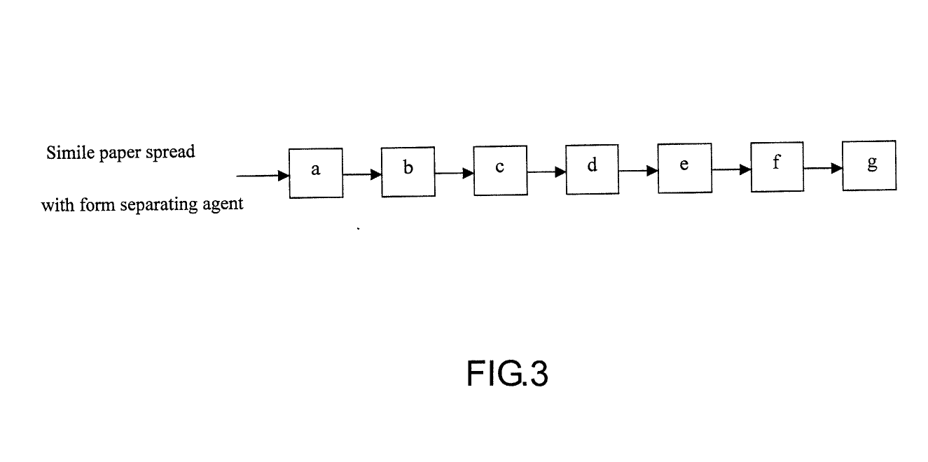

Referring to FIG. 3, when the present invention is applied to the aqua transfer printing, first the simile paper is spread with the form separating agent, then the other materials are used according to the layers of printing: a. the white color (for the base color), b. the yellow color, c. the red color, d. the blue color, e. the black color, f. the application of the plastic film; the accomplishment of the manufacturing procedures completes the aqua transfer paper printing; then this piece of paper is transferred and pasted onto different materials, such as the glass, the ceramic, the porcelain, the enamel, the marble, the wood apparatus and the leather.

In summation of the foregoing sections, the innovative manufacturing method of the present invention is capable of cooperating with different materials in directly printing the colorful patterns on the label paper, the poster, the calendar, the decoration, the clothes and the external case of a mobile phone; the said colorful patterns are capable of storing the light during the daytime and showing the visible luminous colorful patterns during the nighttime; therefore, it provides more choices of fun and innovative products for the young people nowadays and increases the effectiveness of the economic activities; furthermore, the general pedestrians can wear the present invention as luminous objects for distinguishing during the nighttime and to caution the drivers of the running cars to pay attention and thus prevent any traffic accident.

Based on the foregoing sections, the present invention of a luminous color printing method has been actually proved to be capable of specifically achieving the mentioned effects, not only having the practicality and security, but also having the high industrial utilization and further having full innovation and advancement, completely complies with the requirements of being an advanced invention with technical idea, is hereby submitted to the patent bureau for review and the granting of the commensurate patent rights.

1. A luminous color printing method can be applied in the manufacturing procedures of a thermal transfer printing and an aqua transfer printing; the main formula of the said luminous color printing comprises the luminous powder, the fluorescent powder and the transparent printing oil; the feature thereof is that 70% luminous powder plus 30% fluorescent powder plus 1:1 transparent printing oil are mixed by a machine and ground by three tumblers into four blended primary printing colors ready to be applied in the manufacturing procedures, such as the thermal transfer printing or the aqua transfer printing.

2. A luminous color printing method according to claim 1, wherein, the manufacturing procedures of the thermal transfer printing use the form separating paper first, then the other materials are used according to the printing sequence: a. the form separating agent, b. the black color, c. the blue color, d. the red color, e. the yellow color, f. the white color, g. the adhesive glue.

3. A luminous color printing method according to claim 1, wherein, the manufacturing procedures of the aqua transfer printing use the simile paper spread with the form separating agent first, then the other materials are used according to the layers of printing: a. the white color (for the base), b. the yellow color, c. the red color, d. the blue color, e. the black color, f. the application of the plastic film.

4. A luminous color printing method according to claim 1, wherein, the method cooperates with different materials in directly printing the colorful patterns onto the label paper, the poster, the calendar, the decoration, the clothes and the external case of a mobile phone; the said colorful patterns are capable of storing the light during the daytime and showing the visible luminous colorful patterns during the nighttime.
